(19) United States
(12) Patent Application Publication
(10) Pub. No.: US 2018/0298252 A1
(43) Pub. Date: Oct. 18, 2018

(54) SILYL TERMINATED POLYMER ADHESIVES

(71) Applicant: Dow Global Technologies LLC, Midland, MI (US)

(72) Inventors: Lirong Zhou, Rochester Hills, MI (US); Daniel P. Sophiea, Lake Orion, MI (US); Charles Eslinger, Harrison Township, MI (US)

(21) Appl. No.: 15/578,787

(22) PCT Filed: May 24, 2016
(86) PCT No.: PCT/US2016/033916

§ 371 Date: Dec. 1, 2017

Related U.S. Application Data
(60) Provisional application No. 62/169,721, filed on Jun. 2, 2015.

(51) Int. Cl. C09J 175/08; C09J 171/00

(52) U.S. Cl. CPC C09J 175/08; C09J 171/00

(57) ABSTRACT

A one part moisture curable adhesive composition having improved heat stability is comprised of a silyl terminated polymer, a catalyst and a particular phosphite compound. The phosphite compound has three groups wherein at least two of the groups are aryl groups, but preferably all three of the groups are aryl groups. The one part moisture curable adhesive composition is useful in severe applications such as solar panels and automotive and building window glass.

### FIELD OF INVENTION

The invention relates to silyl modified polymers (SMPs) useful in adhesives that may be subject to high use temperatures. In particular, the invention is useful to bond glass into vehicles and buildings.

### BACKGROUND OF INVENTION

One-component, moisture-curing adhesives and sealants have for years played an important part in numerous technical applications. As well as the polyurethane adhesives and sealants with free isocyanate groups and the traditional silicone adhesives and sealants based on dimethylpolysiloxanes, there has recently also been increasing use of so-called silane-modified adhesives and sealants. Compared with polyurethane adhesives and sealants, the silane-modified adhesives and sealants have the advantage that they are free from isocyanate groups, in particular, from monomeric diisocyanates. Furthermore, they are distinguished by a broad range of adhesion to a wide variety of substrates without any surface pretreatment by primers or adhesion promoters as is often the case in polyurethane adhesives.

Silane modified polymers (SMPs) have been used to replace the moisture curable polyurethane based adhesives. SMPs generally are comprised of flexible polymeric backbones that are terminated by moisture reactive (hydrolyzable) silane terminal groups. SMPs, generally, have been made by three routes. The first, illustrated by U.S. Pat. No. 3,971,751, involves hydrosilylating a silicon hydride having hydrolyzable silyl groups with an allyl terminated polyether, where the allyl terminated polyether was formed from a polyether polyol. Unfortunately, these SMPs tend to be expensive due to the cost to fabricate the allyl terminated polyether due to the use of chlorine and alkali that must be removed and disposed. The second illustrated by U.S. Pat. No. 3,632,557, generally involves reacting an aminosilane with an isocyanate terminated prepolymer resulting in trialkoxysilyl end groups with polyether polymer backbones containing urea linkages. Adhesives with these prepolymers tend to have high viscosities and low elongation. The third, illustrated by U.S. Pat. Nos. 4,625,012 and 6,355,127 involves reacting an isocyanato organosilane with a polyurethane having terminal active hydrogens. Likewise, these have suffered from high viscosities and low elongations.

Recently, PCT Appl, Nos. WO2012/003212, WO2012/003216, and WO2012/003187 have described hydrosilylating a silicon hydride having hydrolyzable silyl groups with an allyl terminated polyether, where the polyether has only one allyl terminal group and the other terminal group is an alcohol. After hydrosilylation, the terminal alcohol is reacted with a diisocyanate resulting in urethane linkage and isocyanate terminal group. This is then reacted with a polyether polyol to form SMPs.

Demands relating to the long-term temperature resistance of adhesives, sealants and coating compositions are becoming ever higher such as for installation of solar panels and automobile windshields. Thus, there is a need for temperature-resistant compositions which are suitable for use as an adhesive which additionally have a series of other properties that are required in the area of application.

The object of the present invention is therefore to provide a moisture curable composition which avoids toxological issues associated with polyurethane adhesives (i.e., presence of free isocyanate), has good elasticity properties and a broad range of adhesion, and is distinguished in particular by very good long-term temperature stability after curing.

### SUMMARY OF INVENTION

The invention overcomes problems associated with known one-part thermosetting sealant compositions by achieving rapid, deep curing without significant shrinkage and realizing excellent long term high temperature stability useful in challenging uses such as solar panels and automotive and building window glass applications. The advantages of this invention are achieved by employing a one-part moisture curable adhesive composition comprised of a silyl-terminated polymer (SMP) and particular phoshite heat stabilizing compound.

A first aspect of the invention is one part moisture curable adhesive composition, comprising:

a) a silyl terminated polymer,

b) a silanol condensation reaction catalyst,

c) a phosphite compound of the formula:

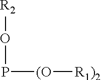

where R₁ is a C₆₋₂₀ aryl, and R₂ is a C₆₋₂₀ aryl, C₆₋₃₀ alkyl, or

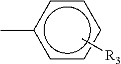

where R₃ is C₆₋₃₁₃ alkyl.

A second aspect of this invention is a method of bonding two or more substrates together comprising,
(i) delivering the adhesive composition of claim 1 to an application nozzle,
(ii) applying a bead of the adhesive composition from step (i) through the application nozzle on to at least a portion of at least one of the substrates,
(iii) contacting the substrates to be bonded and
(iv) allowing the adhesive composition to moisture cure.

A variety of substrates may be bonded together using the adhesive composition of this invention. Examples include plastics, glass, wood, ceramics, metal, coated substrates, such as plastics with an abrasion resistant coating disposed thereon, and the like. The compositions of the invention may be used to bond similar and dissimilar substrates together. The compositions are especially useful for bonding glass or a plastic with an abrasion resistant coating disposed thereon to other substrates such as vehicles and buildings. The compositions of the invention are also useful in bonding parts of modular components together, such as vehicle modular components. The glass or plastic with an abrasion resistant coating disposed thereon can be bonded to coated and uncoated portions of vehicles.

It has been surprisingly discovered that the adhesive composition of the first aspect of the invention has improved heat stability with very little addition of the phosphite compound without the need for any further stabilizers even though other stabilizers may be added.

Furthermore, the adhesive demonstrates rapid strength development which facilitates rapid drive away times of preferably one hour, and more preferably 30 minutes, after application of the adhesive at temperatures of from about 0° F. (−18° C.) to about 115° F. (46° C.). In particular, windshields installed under such conditions meet United States Federal Motor Vehicle Safety Standard (FMVSS) 212.

### DETAILED DESCRIPTION OF INVENTION

The adhesive composition of the invention is comprised of a silyl terminated polymer (SMP). Examples of suitable SMPs include those known in the art such as silylated polyurethane, silylated polyethers, and silylated polyesters. The silylated polymers or silyl-terminated polymers of this invention include two or more reactive silyl groups. The SMP may be linear or branched.

An example of a suitable silyl-terminated polymer is an oxyalkylene polymer having at least one reactive silyl group at each end of the polymer molecule. The backbone of the silyl-terminated oxyalkylene polymer has repeating units represented by the formula: —R—O— wherein R represents a divalent organic group, preferably a straight or branched alkylene group containing 1 to 14 carbon atoms, and more preferably straight or branched alkylene groups containing 2 to 4 carbon atoms (e.g., ethylene oxide, propylene oxide and butylene oxide). Desirably, the backbone is a polypropylene oxide backbone, polyethylene oxide backbone, and co-polyethylene oxide/polypropylene oxide backbone.

The SMP is terminated by an end group of the general formula (I):

-Aₙ-R—SiXYZ

where A is a divalent linking group comprising at least one heteroatom, R is a divalent hydrocarbon residue with 1-12 C atoms and X, Y, Z are substituents on the Si atom and are, independently of one another, C₁-C₈ alkyl, C₁-C₈ alkoxy or C₁-C₈ acyloxy groups, wherein at least one of the residues X, Y, Z is a C₁-C₈ alkoxy or C₁-C₈ acyloxy group, and n is 0 or 1.

The divalent linking group A comprising at least one heteroatom is understood to be a divalent chemical group which links the polymer backbone of the alkoxysilane and/or acyloxysilane-terminated polymer with the residue R of the end group. The divalent linking group A can be formed, for example, during the production of the alkoxysilane and/or acyloxysilane-terminated polymer, for example as an amide or urethane group by the reaction of a polyether which is functionalized with hydroxy groups with an isocyanatosilane. The divalent linking group can be either capable or incapable of being differentiated from structural features occurring in the underlying polymer backbone. The latter is the case, for example, if it is identical with the linking points of the repeating units of the polymer backbone.

The index “n” corresponds to 0 (zero) or 1, i.e., the divalent linking group A links the polymer backbone with the residue R (n=1) or the polymer backbone is bound or linked directly with the residue R (n=O).

The residue R is a divalent hydrocarbon residue with 1 to 12 C atoms. The hydrocarbon residue can be a straight, chained, branched or cyclic alkylene residue. The hydrocarbon residue can be saturated or unsaturated. R is preferably a divalent hydrocarbon residue with 1 to 6 C atoms. Preferably, R is a methylene, ethylene or n-propylene group, in particular, a methylene or n-propylene residue.

The substituents X, Y and Z which are directly bound with the Si atom are, independently of one another, C₁-C₈ alkyl, C₁-C₈ alkoxy or C₁-C₈ acyloxy. At least one of X, Y, Z is a hydrolyzable group, i.e., a C₁-C₈ alkoxy or a C₁-C₈ acyloxy. The hydrolyzable groups are preferably alkoxy groups, in particular, methoxy, ethoxy, i-propyloxy and i-butyloxy groups. This is advantageous, since no substances which irritate mucous membranes are released during the curing of compositions comprising alkoxy groups.

Methods of introducing a reactive silyl group onto a polymer, such as a polyether, or more specifically a polyoxyalkylene polymer, are well known in the art. For example, polymers having terminal hydroxyl, epoxy or isocyanate functional groups may be reacted with a compound having a reactive silyl group and a functional group capable of reacting with the hydroxyl, epoxy or isocyanate group. As another example, silyl-terminated polyurethane polymers may be used. A suitable silyl-terminated polyurethane polymer may be prepared by reacting a hydroxyl-terminated polyether, such as a hydroxyl-terminated poly-oxyalkylene, with a polyisocyanate compound, such as 4,4′-methylenebis-(phenylisocyanate), to form an isocyanate-terminated polymer, which can then be reacted with an aminosilane, such as aminopropyltrimethoxysilane, to form a silyl-terminated polyurethane. Suitable SMPs having a polyurethane polymer backbone may made by the methods described in WO2012/003212, WO2012/003216, and WO2012/003187.

In a particular embodiment where the SMP has a polyurethane polymer backbone, it is preferred the polymer backbone is comprised of an alkylene oxide such as previously described and at least three urethane groups. In this embodiment, it is desirable for each silicon atom in the terminal groups is separated from the urethane groups in the polymeric backbone by an amount of alkylene oxide that has a molecular weight of 200 to 15,000 g/mole.

The silyl-terminated polymers used in this invention may be straight, chained or branched. The SMPs typically have a number average molecular weight of 500 to about 60,000 g/mole. The “molecular weight average” used herein is the number average molecular weight (Mₙ) as defined on page 189 of Textbook of Polymer Science, 3^{rd} Edition, Billmeyer, F. W. Jr., John Wiley and Sons, NY, N.Y., 1984. Desirably, the Mₙ average may be at least: 1,000; 2,000; 5,000; and 10,000 to at most about 50,000 or about 40,000. The number average molecular weight can be determined by gel permeation chromatograpy using PEG standards.

Suitable silyl-terminated polymers having a polyether polymer backbone are commercially available from Kaneka Corporation under the tradenames KANEKA MS POLYMER™ and KANEKASILYL™. Suitable SMPs having a polyurethane polymer backbone are commercially available from The Dow Chemical Company under the tradename VORASIL™.

The number average molecular weight can be determined by measuring the terminal groups. Specifically, when the polyoxyalkylene polymer is linear or branched type polymer, the molecular weight can be determined by obtaining a hydroxyl value (OHV; meq/g) per a unit weight and an unsaturated value (IV; meq/g) from a known method, followed by calculating it with the formula: 2000/(IV+OHV). Alternatively, the number average molecular weight can be determined by gel permeation chromatograpy using PEG standards.

The SMP typically exhibits a viscosity that is about 100,000 centipoise (100 Pa s) or less and more preferably about 50,000 centipoise (50 Pa s) or less, and most preferably about 30,000 centipoise (30 Pa s) or less and about 1,000 centipoise (1 Pa s) or greater. The viscosity used herein is Brookfield viscosity determined using a number 5 spindle. The viscosity of the adhesive can be adjusted with fillers, although the fillers generally do not improve the green strength of the final adhesive. Below about 1,000 centipoise (1 Pa s), the adhesive prepared from the SMP may exhibit poor green strength. Above about 100,000 centipoise (100 Pa s), the SMP may be unstable or hard to dispense or gel.

The one part moisture curable adhesive composition also comprises a phosphite compound that has surprisingly been found to substantially improve the heat stability of the SMPs even without other known heat stabilizing additives such as UV absorbers (hindered amine light stabilizers “HALs”) or antioxidants such as sterically hindered phenolic antioxidants. These other alternative stabilizing additives of course may be used, but may not be necessary. These other stabilizing additives include, for example, antioxidants and UV stabilizers such as HALS (e.g., IRGANOX and TINUVIN antioxidants/UV stabilizers available from BASF), sterically hindered phenols, benzotriazole or benzophenone derivatives.

The phosphite compound has the general formula:

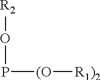

where R₁ is a C₆₋₂₀ aryl, and R₂ is a C₆₋₂₀ aryl, C₆₋₃₀ alkyl, or

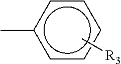

where R₃ is C₆₋₃₀ alkyl. Preferably, R₂ is C₆₋₂₀ aryl and more preferably R₂ and/or R₁ are:

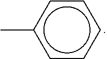

Such phosphite compounds are commercially available under the tradename DOVERPHOS from Dover Chemical Corporation.

The amount of phosphite compound in the adhesive composition is typically an amount of about 0.01% to 2% by weight of the adhesive composition. Desirably, the amount is at most about 1.5%, 1.0% or 0.8% to at least about 0.1% by weight of the adhesive composition.

The adhesive composition of the invention also comprises a silanol condensation catalyst. The catalyst catalyzes the reaction of the hydrolyzable silane moieties with water and may be any known in the art such as those containing tin. Exemplary catalysts include: titanic acid esters (e.g., tetrabutyl titanate and tetrapropyl titanate); organotin compounds (e.g., dibutyltin dilaurate, dibutyltin maleate, dibutyltin diacetate, tin octylate, tin naphthenate, reaction products of dibutyltin oxide and phthalic acid esters, dialkyltin diacetyl acetonates such as, dibutyltin bis(acetylacetonate)). More preferably the catalyst is a dialkyltin oxide; such as dibutyltin oxide; dialkyltin bisacetyl acetonate; or the reaction product of diakyltin oxide with a phthalic ester or pentanedione.

The catalyst is present in an amount of about 60 parts per million or greater based on the total weight of the adhesive composition, more preferably 120 parts by million or greater. The catalyst is present in an amount of about 2 percent or less based on the weight of the adhesive, more preferably 1.5 percent by weight or less and most preferably 0.5 percent by weight or less.

The adhesive composition may also be comprised of a filler. Suitable fillers include those known in the art. Illustratively, the filler may be a hydrophilic, hydrophobic filler or combination thereof. The total amount of filler present in the adhesive composition is generally from about 15% to 50% by weight of the adhesive composition. Some of the filler may be a carbon black. “Standard carbon black” is carbon black which is not specifically surface treated or oxidized to render it nonconductive. One or more nonconductive carbon blacks may be used in conjunction with the standard carbon black, although such inclusion may add unnecessary costs. The amount of carbon black in the composition is that amount which provides the desired color, viscosity, sag resistance and strength and generally is within the aforementioned range.

The carbon blacks depending on their structure may range over a wide range of structures as given by oil absorption number (ASTM D-2414-09). For example, the carbon black typically should be an oil absorption number (OAN) of about 80 to 200 ccs per 100 grams. Preferably, the oil absorption of the carbon is at least about 90, more preferably at least about 100, and most preferably at least about 110 to preferably at most about 180, more preferably at most about 165 and most preferably at most about 150 ccs/100 grams. In addition the carbon black desirably has an iodine number that is at least 80. The iodine number is related to the surface area of the carbon black, but also to the presence of volatile species such as unsaturated oils and, sulfur containing compounds. The iodine number is determined using ASTM D1510-11.

Carbon blacks useful in the composition include, for example, RAVEN™ 790, RAVEN™ 450, RAVEN™ 500, RAVEN™ 430, RAVEN™ 420 and RAVEN™ 410 carbon blacks available from Colombian and CSX™ carbon blacks available from Cabot, and PRINTEX™ 30 carbon black available from Degussa. Nonconductive carbon blacks are well known in the art and include RAVEN™ 1040 and RAVEN™ 1060 carbon black available from Colombian.

Other fillers may also be used alone or in combination with carbon black. For example, other hydrophilic fillers may be used in combination with carbon black. A suitable hydrophilic filler is clay. Typically, the clay has a specific surface area of at least 5 m²/g. Clays useful in the invention include kaolin, surface treated kaolin, calcined kaolin, aluminum silicates and surface treated anhydrous aluminum silicates. The clays can be used in any form which facilitates formation of the adhesive composition with the desired properties. Preferably, the clay is admixed in the form of pulverized powder, spray-dried beads or finely ground particles. It is also desirable for the clay to be calcined (heat treated to remove or reduce the hydrated water of the clay). An example of a suitable clay is Polestar 200R (IMERYS) (55% SiO₂, 45% Al₂O₃) with an average particle size of about 2 micrometers, and a BET surface of 8.5 m²/g.

In a preferred embodiment, it may be advantageous to have an additional hydrophobic filler in combination with the hydrophilic filler. Hydrophobic filler are fillers that have been hydrophobically modified. Modifications include coatings with organosilanes or fatty acids. “Hydrophobic filler” used herein is generally precipitated calcium carbonate with spherical morphology, coated with fatty acids. The coating level is approx. 1 to 5%. It has been discovered that the hydrophobic filler, when present in a sufficient amount, may improve one or more properties such as the shear modulus obtained without loss in the impact resistance. Generally, the hydrophobic filler is present in an amount that is from greater than 0% to 50% by weight of the total amount of hydrophilic filler and hydrophobic filler (not including carbon black). Preferably, the amount is from 5%, 10% or 15% to 40% or 35%.

An example of a suitable hydrophobic filler is calcium carbonate that has been treated to render it hydrophobic, which is well known in the art. Hydrophobic calcium carbonates illustratively are typically treated/coated with organic acids or esters of organic acids to render them hydrophobic. Examples of suitable hydrophobic fillers include those available from Shiraishi Kogyo Kaisha LTD. under the tradename HAKEUNKA and M.P.I. Pharmaceutica GmBH, Hamburg, Germany. Another illustrative hydrophobic filler may be fumed silica such as those available from Wacker Chemie AG, Munich, Germany.

The compositions of this invention may further comprise plasticizers so as to modify the rheological properties to a desired consistency. Such materials should be free of water, inert to isocyanate groups and compatible with the SMP. The compositions of the invention preferably comprise two plasticizers with one being a high polar plasticizer and one being a low polar plasticizer. A high polar plasticizer is a plasticizer with a polarity greater than the polarity of the aromatic diesters, such as the phthalate esters. A low polar plasticizer is a plasticizer which has a polarity the same as or less than the aromatic diesters.

Suitable high polar plasticizers include one or more of alkyl esters of sulfonic acid, alkyl alkylethers diesters, polyester resins, polyglycol diesters, polymeric polyesters, tricarboxylic esters, dialkylether diesters, dialkylether aromatic esters, aromatic phosphate esters, and aromatic sulfonamides. More preferred high polar plasticizers include aromatic sulfonamides, aromatic phosphate esters, dialkyl ether aromatic esters and alkyl esters of sulfonic acid. Most preferred high polar plasticizers include alkyl esters of sulfonic acid and toluene-sulfamide. Alkyl esters of sulfonic acid include alkylsulphonic phenyl ester available from Lanxess under the trademark MESAMOLL. Aromatic phosphate esters include PHOSFLEX™ 31 L isopropylated triphenyl phosphate ester, DISFLAMOLL™ DPO diphenyl-2-ethyl hexyl phosphate, and DISFLAMOL™ TKP tricresyl phosphate. Dialkylether aromatic esters include BENZOFLE™ 2-45 diethylene glycol dibenzoate. Aromatic sulfonamides include KETJENFLE™ 8 o and p, N-ethyl toluenesulfonamide.

Suitable low polar plasticizers include one or more aromatic diesters, aromatic triesters, aliphatic diesters, epoxidized esters, epoxidized oils, chlorinated hydrocarbons, aromatic oils, alkylether monoesters, naphthenic oils, alkyl monoesters, glyceride oils, parraffinic oils and silicone oils. Preferred low polar plasticizers include alkyl phthalates, such as diisononyl phthalates, dioctylphthalate and dibutylphthalate, partially hydrogenated terpene commercially available as “HB-40”, epoxy plasticizers, chloroparaffins, adipic acid esters, castor oil, toluene and alkyl naphthalenes. The most preferred low polar plasticizers are the alkyl phthalates.

The amount of low polar plasticizer in the adhesive composition is that amount which gives the desired rheological properties and which is sufficient to disperse the catalyst in the system. The amounts disclosed herein include those amounts added during preparation of the prepolymer and during compounding of the adhesive. Preferably, low polar plasticizers are used in the adhesive composition in an amount of about 5 parts by weight or greater based on the weight of the adhesive composition, more preferably about 10 parts by weight or greater, and most preferably about 18 parts by weight or greater. The low polar plasticizer is preferably used in an amount of about 40 parts by weight or less based on the total amount of the adhesive composition, more preferably about 30 parts by weight or less and most preferably about 25 parts by weight or less.

The amount of high polar plasticizer in the adhesive composition is that amount which gives the desired rheological properties and the acceptable sag and string properties. Preferably, the high polar plasticizers are used in the adhesive composition in an amount of about 0.2 parts by weight or greater based on the weight of the adhesive composition, more preferably about 0.5 parts by weight or greater, and most preferably about 1 part by weight or greater. The high polar plasticizer is preferably used in an amount of about 20 parts by weight or less based on the total amount of the adhesive composition, more preferably about 12 parts by weight or less and most preferably about 8 parts by weight or less.

The adhesive composition of this invention may further comprise moisture stabilizers, which function to protect the adhesive composition from moisture, thereby inhibiting advancement and preventing premature crosslinking of the silyl terminated prepolymers in the adhesive composition. Stabilizers known to the skilled artisan for moisture curing adhesives may be used. Included among such stabilizers are diethylmalonate, alkylphenol alkylates, paratoluene sulfonic isocyanates, benzoyl chloride and orthoalkyl formates. Such stabilizers are preferably used in an amount of about 0.1 parts by weight or greater based on the total weight of the adhesive composition, preferably about 0.5 parts by weight or greater and more preferably about 0.8 parts by weight or greater. Such stabilizers are used in an amount of about 5.0 parts by weight or less based on the weight of the adhesive composition, more preferably about 2.0 parts by weight or less and most preferably about 1.4 parts by weight or less.

The adhesive composition may further comprise a hydrophilic material that functions to draw atmospheric moisture into the composition. This material enhances the cure speed of the formulation by drawing atmospheric moisture to the composition. Preferably, the hydrophilic material is a liquid. Among preferred hydroscopic materials are pyrolidinones such as 1 methyl-2-pyrolidinone, available from under the trademark M-PYROL. The hydrophilic material is preferably present in an amount of about 0.1 parts by weight or greater and more preferably about 0.3 parts by weight or greater and preferably about 1.0 parts by weight or less and most preferably about 0.6 parts by weight or less.

As used herein, all parts by weight relative to the components of the adhesive composition are based on 100 total parts by weight of the adhesive composition.

The adhesive composition of this invention may be formulated by blending the components together using means well known in the art. Generally, the components are blended in a suitable mixer. Such blending is preferably conducted in an inert atmosphere in the absence of oxygen and atmospheric moisture to prevent premature reaction. In embodiments, it may be advantageous to add any plasticizers to the reaction mixture for preparing the silyl terminated prepolymer so that such mixture may be easily mixed and handled. Alternatively, the plasticizers can be added during blending of all the components. Once the adhesive composition is formulated, it is packaged in a suitable container such that it is protected from atmospheric moisture and oxygen. Contact with atmospheric moisture and oxygen could result in premature crosslinking of the silyl terminated prepolymer.

The adhesive composition of the invention is used to bond a variety of substrates together as described hereinbefore. The composition can be used to bond porous and nonporous substrates together. The adhesive composition is applied to a substrate and the adhesive on the first substrate is thereafter contacted with a second substrate. The surfaces to which the adhesive is applied may be cleaned and primed prior to application if desired, see for example, U.S. Pat. Nos. 4,525,511; 3,707,521 and 3,779,794; relevant parts of all are incorporated herein by reference. Generally, the adhesives of the invention are applied at ambient temperature in the presence of atmospheric moisture. Exposure to atmospheric moisture is sufficient to result in curing of the adhesive. Curing can be accelerated by the addition of additional water or by applying heat to the curing adhesive by means of convection heat, microwave heating and the like. Preferably, the adhesive of the invention is formulated to provide a working time of about 6 minutes or greater, and more preferably about 12 minutes or greater. Preferably, the working time is about 60 minutes or less and more preferably about 30 minutes or less.

The adhesive composition is preferably used to bond glass or plastic coated with an abrasion resistant coating, to other substrates such as bare or painted metals or plastics. In a preferred embodiment, the first substrate is a glass, or plastic coated with an abrasion resistant coating, and the second substrate is a window frame. In another preferred embodiment, the first substrate is a glass, or plastic coated with an abrasion resistant coating, and the second substrate is a window frame of an automobile. The plastic coated with an abrasion resistant coating can be any plastic which is clear, such as polycarbonate, acrylics, hydrogenated polystyrene or hydrogenated styrene conjugated diene block copolymers having greater than 50 percent styrene content. The coating can comprise any coating which is abrasion resistant such as a polysiloxane coating. Preferably, the coating has an ultraviolet pigmented light blocking additive. Preferably, the glass or plastic window has an opaque coating disposed in the region to be contacted with the adhesive to block UV light from reaching the adhesive.

In a preferred embodiment, the composition of the invention is used to replace windows in structures or vehicles and most preferably in vehicles. The first step is removal of the previous window. This can be achieved by cutting the bead of the adhesive holding the old window in place and then removing the old window. Thereafter, the new window may be cleaned and primed. The old adhesive that is located on the window flange can be removed, although it is not necessary and in most cases it is left in place. The window flange may also be primed with a paint primer. The adhesive is applied in a bead to the periphery of the window located such that it will contact the window flange when placed in the vehicle. The window with the adhesive located thereon is then placed into the flange with the adhesive located between the window and the flange. The adhesive bead is a continuous bead that functions to seal the junction between the window and the window flange. A continuous bead of adhesive is a bead that is located such that the bead connects at each end to form a continuous seal between the window and the flange when contacted. Thereafter the adhesive is allowed to cure.

In another embodiment, the compositions of the invention can be used to bond modular components together. Examples of modular components include vehicle modules, such as door, window or body.

### Illustrative Embodiments of the Invention

The following examples are provided to illustrate the invention, but are not intended to limit the scope thereof. All parts and percentages are by weight unless otherwise indicated.

In each of the Example and Comparative Example compositions, the SMP, DAMO T adhesion promoter, SILQUEST A-171 moisture scavenger, and NEOSTANN U220 catalyst and the stabilizers as shown in Tables 2A and 2B are blended together under a nitrogen atmosphere.

Each of the Example and Comparative Example compositions are placed in an open crucible and allowed to fully cure in air for 10 days at 24° C. and 50% RH. Each cured composition is then heat aged at 90° C., and periodically checked for appearance and degradation (e.g., at least once a day). After fourteen days the aging is stopped and if the composition survived without softening or melting prior to that point, its appearance is noted. The starting appearance (i.e., prior to heat aging) of each of the compositions was white.

Examining the results in Table 3, Examples 1 and 3 employing a phosphite compound where each organic moiety of the phosphite is an aryl moiety realizes an SMP that easily survives the heat aging test with only slight discoloration. This is in contrast to the SMP of Comparative Example 1 without any such stabilizer melted on or before the 7^{th} day and failed the test. Example 3, which also included other stabilizers also survived the heat aging test, but was a darker yellow or brown. Example 2 which used the same SMP as Example 1 and a phosphite stabilizer where only two moieties were aryl survived the heat aged test in a like manner as Example 1.

Comparative Examples 4 to 8, which had the same SMP as Examples 1 to 3, all softened or melted well before 14 days in the heat age test. In each of these, the phosphite stabilizer fails to have two aryl moieties. Comparative Examples 9 to 11, which had the same SMP as Examples 1 to 3, employed a non-phosphite stabilizer and all of these softened or melted by the 7^{th} day of the test.

Example 4, which employed a different SMP than Examples 1 and 3, but the same phosphite stabilizer (all aryl moieties) performed with no noticeable degradation. Likewise, Example 5, which was the same as Example 4, except that additional non-phosphite stabilizers were used, had the same performance as Example 4. Comparative Example 2, which used the same SMP, but no stabilizer softened on the 7^{th} day in the heat age test in a like manner as Comparative Example 1.

Example 6, which employed yet a different SMP, only had a slight discoloration after 14 days of the heat aged test. Comparative Example 3, which used the same SMP without any further addition of a stabilizer turned brown after 14 days of the heat aged test. This SMP appears to have better heat aged performance without a further added stabilizer, which may be due to its differing backbone structure than the SMPs used in Examples 1 to 5. Even so, it still benefited greatly from the addition of the phosphite compound of this invention.

TABLE 1
Raw Materials

| Raw Material | Description | Company |
|---|---|---|
| Kaneka | SMP | Kaneka North America |
| S303H | | LLC |
| VORASIL 602 | Dow SMP | The Dow Chemical Co. |
| VORASIL 604 | Dow SMP | The Dow Chemical Co. |
| VORASIL 606 | Dow SMP | The Dow Chemical Co. |
| DAMO T | N-(2-Aminoethyl)-3- | Evonik Industries |
| | aminopropyltrimethoxy- | |
| | silane (adhesion | |
| | promoter) | |
| SILQUEST A-171 | vinyl silane | Momentive Performance |
| | (moisture scavenger) | Materials Inc. |
| NEOSTANN U220 | Dibutyltin | Kaneka North America |
| | diacetyldiacetonate | LLC |
| | (catalyst) | |
| TINUVIN 765 | HALS | BASF |
| DOVERPHOS 4 | Trisnonylphenyl | Dover Chemical Corp. |
| | Phosphite | |
| IRGANOX 1135 | UVA | BASF |
| IRGANOX 5057 | UVA | BASF |
| DOVERPHOS 7 | Phenyl Diisodecyl | Dover Chemical Corp. |
| | Phosphite | |
| DOVERPHOS 8 | Diphenyl Isodecyl | Dover Chemical Corp. |
| | Phosphite | |
| DOVERPHOS 10 | Triphenyl Phosphite | Dover Chemical Corp. |
| DOVERPHOS 53 | Trilauryl Phosphite | Dover Chemical Corp. |
| DOVERPHOS 613 | Alkyl C12-C15 | Dover Chemical Corp. |
| | Bisphenol A Phosphite | |
| DOVERPHOS 1220 | Diisodecyl | Dover Chemical Corp. |
| | Pentaerythritol | |
| | Diphosphite | |

TABLE 2A
Example Compositions

| | 1 | 2 | 3 | 4 | 5 | 6 |
|---|---|---|---|---|---|---|
| | wt | wt | wt | wt | wt | wt |
| Material | (g) | (g) | (g) | (g) | (g) | (g) |
| KANEKA S303H | | | | | | 40 |
| VORASIL 602 | 20 | 20 | 20 | | | |
| VORASIL 604 | 20 | 20 | 20 | | | |
| VORASIL 606 | | | | 40 | 40 | |
| DAMO T | 0.8 | 0.8 | 0.8 | 0.8 | 0.8 | 0.8 |
| A-171 | 0.85 | 0.85 | 0.85 | 0.85 | 0.85 | 0.85 |
| NEOSTANN U220 | 0.44 | 0.44 | 0.44 | 0.44 | 0.44 | 0.44 |
| TINUVIN 765 | | | | | | |
| DOVERPHOS 4 | | | | | | |
| IRGANOX 1135 | | | 0.5 | | 0.5 | |
| IRGANOX 5057 | | | 0.5 | | 0.5 | |
| DOVERPHOS 7 | | | | | | |
| DOVERPHOS 8 | | 0.5 | | | | |
| DOVERPHOS 10 | 0.5 | | 0.5 | 0.5 | 0.5 | 0.5 |
| DOVERPHOS 53 | | | | | | |
| DOVERPHOS 613 | | | | | | |
| DOVERPHOS 1220 | | | | | | |

TABLE 2B
Comparative Example Compositions

| | 1 | 2 | 3 | 4 | 5 | 6 | 7 | 8 | 9 | 10 | 11 |
|---|---|---|---|---|---|---|---|---|---|---|---|
| | wt | wt | wt | wt | wt | wt | wt | wt | wt | wt | wt |
| Material | (g) | (g) | (g) | (g) | (g) | (g) | (g) | (g) | (g) | (g) | (g) |
| Kaneka S303H | | | 40 | | | | | | | | |
| Vorasil 602 | 20 | | | 20 | 20 | 20 | 20 | 20 | 20 | 20 | 20 |
| Vorasil 604 | 20 | | | 20 | 20 | 20 | 20 | 20 | 20 | 20 | 20 |
| Vorasil 606 | | 40 | | | | | | | | | |
| DAMO T | 0.8 | 0.8 | 0.8 | 0.8 | 0.8 | 0.8 | 0.8 | 0.8 | 0.8 | 0.8 | 0.8 |
| A-171 | 0.85 | 0.85 | 0.85 | 0.85 | 0.85 | 0.85 | 0.85 | 0.85 | 0.85 | 0.85 | 0.85 |
| Neostann U220 | 0.44 | 0.44 | 0.44 | 0.44 | 0.44 | 0.44 | 0.44 | 0.44 | 0.44 | 0.44 | 0.44 |
| Tinuvin 765 | | | | | | | | | | 0.5 | |
| Doverphos 4 | | | | | | 0.5 | | | | | |
| Irganox 1135 | | | | | | | | | 0.5 | | |
| Irganox 5057 | | | | | | | | | | | 0.5 |
| Doverphos 7 | | | | 0.5 | | | | | | | |
| Doverphos 8 | | | | | | | | | | | |
| Doverphos 10 | | | | | | | | | | | |
| Doverphos 53 | | | | | | | 0.5 | | | | |
| Doverphos 613 | | | | | 0.5 | | | | | | |
| Doverphos 1220 | | | | | | | | 0.5 | | | |

TABLE 3
Test Results

| | 90° C. | | |
|---|---|---|---|
| | heat age | | |
| | (days) | Appearance | Stabilizer |
| Ex. 1 | 14 | Slightly | Doverphos 10 |
| | | yellowed | |
| Ex. 2 | 14 | Slightly | Doverphos 8 |
| | | yellowed | |
| Ex. 3 | 14 | Brown | Doverphos 10, Irganox |
| | | | 1135, Irganox 5057 |
| Ex. 4 | 14 | White | Doverphos 10 |
| Ex. 5 | 14 | White | Doverphos 10, Irganox |
| | | | 1135, Irganox 5057 |
| Ex. 6 | 14 | Slight | Doverphos 10 |
| | | discoloration | |
| | | still white | |
| Comp. Ex. 1 | melted < day 7 | | None |
| Comp. Ex. 2 | softened at day 7 | | None |
| Comp. Ex. 3 | 14 | Brown | None |
| Comp. Ex. 4 | softened at day 10 | | Doverphos 7 |
| Comp. Ex. 5 | softened at day 8 | | Doverphos 613 |
| Comp. Ex. 6 | softened at day 7 | | Doverphos 4 |
| Comp. Ex. 7 | melted at day 7 | | Doverphos 53 |
| Comp. Ex. 8 | softened < day 7 | | Doverphos 1220 |
| Comp. Ex. 9 | melted at day 7 | | Irganox 1135 |
| Comp. Ex. 10 | melted at day 7 | | Tinuvin 765 |
| Comp. Ex. 11 | melted at day 7 | | Irganox 5057 |

1. A one part moisture curable adhesive composition, comprising:
a) a silyl terminated polymer,
b) a silanol condensation reaction catalyst,
c) a phosphite compound of the formula: 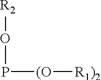
where R₁ is a C₆₋₂₀ aryl, and R₂ is a C₆₋₂₀ aryl, C₆₋₃₀ alkyl, or 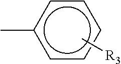
where R₃ is C₆₋₃₀ alkyl.

2. The one part moisture curable adhesive composition of claim 1, wherein R₂ is C₆₋₂₀ aryl.

3. The one part moisture curable adhesive composition of claim 2, wherein R₂ is

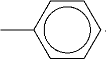

4. The one part moisture curable adhesive composition of claim 1, wherein R₁ is

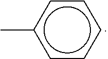

5. The one part moisture curable adhesive composition of claim 1, wherein the silyl terminated polymer is a silyl terminated polyurethane, silyl terminated polyether, silyl terminated polyester or combination thereof.

6. The one part moisture curable adhesive composition of claim 5, wherein the silyl terminated polymer is the silyl terminated polyurethane.

7. The one part moisture curable adhesives composition of claim 6, wherein the silyl terminated polyurethane has a polymeric backbone of alkylene oxide and at least three urethane groups.

8. The one part moisture curable adhesive of claim 7, wherein at least two terminal groups comprised of a silicon atom having at least two alkoxy silane groups, wherein each silicon atom in the terminal groups is separated from the urethane groups in the polymeric backbone by an amount of alkylene oxide that has a molecular weight of 200 to 15,000 g/mole.

9. The one part moisture curable adhesive composition of claim 1, wherein said adhesive composition is in the absence of any other heat stabilizing compound other than the phosphite compound.

10. The one part moisture curable adhesive composition of claim 1, further comprising at least one of the following: a plasticizer; filler; moisture stabilizer; moisture scavenger; and hydrophilic material.

11. The one part moisture curable adhesive composition of claim 1, wherein the silyl terminated polymer is linear.

12. The one part moisture curable adhesive composition of claim 8, wherein each of the urethane groups in the polymeric backbone of alkylene oxide is separated from each other by an amount of alkylene oxide having a molecular weight of 1,000 to 12,000 g/mole.

13. The one part moisture curable adhesive composition of claim 7, wherein there are at most six urethane groups.

14. The one part moisture curable adhesive composition of claim 1, wherein the silyl terminated polymer is branched.

15. The one part moisture curable adhesive composition claim 5, wherein the amount of the phosphite compound is from 0.01 to 2% by weight of said adhesive composition.

16. The one part moisture curable adhesive composition of claim 10, wherein said adhesive composition is comprised of the filler and the filler is present in an amount of 15% to 50% by weight.

17. The one part moisture curable adhesive composition of claim 16, wherein said adhesive composition is comprised of the plasticizer.

18. The adhesive composition of claim 1, wherein the catalyst is a tin catalyst.

19. The adhesive composition of claim 1, wherein the silyl terminated prepolymer has a number average molecular weight of 8,000 to 40,000.

20. A method of bonding two or more substrates together comprising;
(i) delivering the adhesive composition of claim 1 to an application nozzle,
(ii) applying a bead of the adhesive composition from step (i) through the application nozzle on to at least a portion of at least one of the substrates,
(iii) contacting the substrates to be bonded and
(iv) allowing the adhesive composition to moisture cure.
